(19) United States
(12) Patent Application Publication
(10) Pub. No.: US 2018/0228126 A1
(43) Pub. Date: Aug. 16, 2018

(54) Easy Feed Pet Bowl System

(71) Applicant: Synergy Now LLC, Brighton, CO (US)

(72) Inventors: Jana Denise Curtin, Brighton, CO (US); Ira August Sealy, Littleton, CO (US)

(73) Assignee: Synergy Now LLC, Brighton, CO (US)

(21) Appl. No.: 15/897,136

(22) Filed: Feb. 14, 2018

Related U.S. Application Data
(60) Provisional application No. 62/459,557, filed on Feb. 15, 2017.

(51) Int. Cl. A01K 5/01

(52) U.S. Cl. CPC A01K 5/0114

(57) ABSTRACT

A pet bowl system for providing feed to a pet includes a bowl for containing the feed, and an inherent post integrally formed from the bowl. The inherent post includes a plurality of protrusions thereon. The system also includes a handle for attaching to the bowl via the inherent post. The handle includes an attachment apparatus configured for removably engaging with the plurality of protrusions on the inherent post, thereby attaching the handle to the bowl.

### CROSS-REFERENCE TO RELATED APPLICATION

The present invention claims the benefit of U.S. Provisional Application No. 62/459,557 filed on Feb. 15, 2017.

### FIELD OF THE INVENTION

The present invention relates generally to pet food or water dishes and, more particularly, pertains to pet dishes with handles.

### BACKGROUND OF THE INVENTION

A pet bowl, or pet dish, is generally intended to supply food or water to household pets or small livestock such as, but not limited to, dogs, cats, goats, chickens, and pigs. Pet food or water bowls are typically picked up from the floor or ground, placed on a higher work surface, such as a table or countertop, filled, then placed back on the floor or ground to allow access for the pet to eat or drink.

Picking up the pet bowl from the floor, returning the bowl to the floor, or moving the bowl to different locations can be difficult and, in some cases, not possible for many pet owners, especially the elderly, physically disabled, or people with limited mobility.

### SUMMARY OF THE INVENTION

In accordance with the embodiments described herein, there is provided a pet bowl system for providing feed (e.g., pet food, water) to a pet. The system includes a bowl for containing the feed, and an inherent post integrally formed from the bowl. The inherent post includes a plurality of protrusions thereon. Additionally, the system includes a handle for attaching to the bowl via the inherent post. The handle includes an attachment apparatus configured for removably engaging with the plurality of protrusions on the inherent post, thereby attaching the handle to the bowl. In an embodiment, the inherent post protrudes upward from a center of the bowl.

In accordance with another embodiment, the attachment apparatus is further configured for removably engaging with the plurality of protrusions on the inherent post by twisting the attachment apparatus onto the inherent post. The attachment apparatus fully engages the plurality of protrusions on the inherent post by twisting the attachment apparatus onto the inherent post by less than a full turn of the attachment apparatus, in accordance with an embodiment. In an alternative embodiment, the attachment apparatus fully engages the plurality of protrusions on the inherent post by twisting the attachment apparatus on the inherent post by less than a half turn of the attachment apparatus.

In accordance with still another embodiment, the handle further includes a grip arrangement, such as a foam grip, a rubber grip, and a T-bar grip. In an alternative, the handle is collapsible. In yet another alternative, the handle includes a telescoping mechanism for adjusting an overall length of the handle.

In yet another embodiment, the pet bowl system includes a stand for elevating the bowl off of a floor. The stand is removably attached to the bowl, in an embodiment. In an alternative embodiment, the stand is integrally formed from the bowl. In a further embodiment, the handle includes an opening for accommodating a hook therein for hanging the handle by the opening on the hook.

In accordance with a further embodiment, a pet bowl system for providing feed to a pet includes a bowl for containing the feed. The system further includes an inherent post upwardly protruding and attached to the bowl. The inherent post includes a plurality of protrusions thereon. The system also includes a handle for attaching to the bowl via the inherent post, the handle including an attachment apparatus configured for removably engaging with the plurality of protrusions on the inherent post by less than a full turn of the attachment apparatus onto the inherent post.

In another embodiment, a method for providing feed to a pet includes providing a bowl for containing the feed. The bowl includes an inherent post integrally formed therefrom and in turn including a plurality of protrusions thereon. The method further includes providing a handle for attaching to the bowl via the inherent post. The handle includes an attachment apparatus configured for removably engaging with the plurality of protrusions on the inherent post. The method also includes engaging the handle onto the inherent post by pushing the attachment apparatus onto the inherent post, then twisting the handle by less than a full turn in a first direction, thus removably coupling the attachment apparatus onto the inherent post. The method additionally includes lifting the handle upward so as to raise the bowl onto a work surface, filling the bowl with feed, and, using the handle, lowering the bowl from the work surface down to a lower location. The method then includes disengaging the handle from the bowl by twisting the handle in a second direction, opposite from the first direction.

### BRIEF DESCRIPTION OF THE DRAWINGS

FIG. 1 is a perspective view of a pet bowl feeding system including a single cavity bowl and a handle with attachment apparatus, in accordance with an embodiment.

FIG. 2 is a perspective view of a pet bowl feeding system including a divided cavity bowl and a handle with attachment apparatus, in accordance with an embodiment.

FIGS. 3a-3f are various perspective views illustrating a method for using a pet bowl feeding system, in accordance with an embodiment.

FIG. 4 is a top perspective view of a single cavity bowl, in accordance with an embodiment.

FIG. 5 is a top view of a single cavity bowl with an optional raised design, in accordance with an embodiment.

FIG. 6 is a bottom perspective view of a single cavity bowl, in accordance with an embodiment.

FIG. 7 is a bottom perspective view of a single cavity bowl with an optional raised design, in accordance with an embodiment.

FIG. 8 is a side elevation cross section of an exemplary embodiment of an inherent post in a single cavity bowl.

FIG. 9 is a cross sectional view of an inherent post with a handle attachment apparatus in a single cavity bowl, in accordance with an embodiment.

FIG. 10 is a top perspective view of a single cavity bowl with an attachment apparatus attached thereto, in accordance with an embodiment.

FIG. 11 is a side perspective view of a single cavity bowl, in accordance with an embodiment.

FIG. 12 is a side view of a single cavity bowl, in accordance with an embodiment.

FIG. 13 is a side view of a single cavity bowl, as viewed from a different angle from FIG. 12, in accordance with an embodiment.

FIG. 14 is a top view of a divided cavity bowl, in accordance with an embodiment.

FIG. 15 is a perspective view of a divided cavity bowl, in accordance with an embodiment.

FIG. 16 is a bottom perspective view of a divided cavity bowl, in accordance with an embodiment.

FIG. 17 is a side view of a divided cavity bowl, in accordance with an embodiment.

FIG. 18 is a side perspective view of a divided cavity bowl, in accordance with an embodiment.

FIG. 19 is a side view of a single cavity bowl, including an optional stand, in accordance with an embodiment.

FIG. 20 is a bottom perspective view of a single cavity bowl, including an optional stand, in accordance with an embodiment.

FIG. 21 is a bottom perspective view of a removable, optional stand, in accordance with an embodiment.

FIGS. 22-27 illustrate various views of an attachment apparatus, in accordance with an embodiment.

### DETAILED DESCRIPTION OF EMBODIMENTS OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

In particular, the term “pet” as used herein includes any and all types of animals such as, but not limited to, domesticated or non-domesticated animals such as canine, feline, caprine, swine, ovine, bovine, equine or chicken species, male or female.

The term “food” as used herein includes food, hard or soft in substance, water or other nourishment an individual may choose to feed to a pet.

The present invention seeks to solve the problems described in the Background by providing a pet bowl feeding system that is easy to use and does not require the user to bend over, kneel, or otherwise reach to the floor to pick up an empty pet bowl or to replace a full pet bowl on the floor. In an exemplary embodiment, a single or double pet bowl feeding system includes a removable handle, which easily attaches to and releases from the bowl. This system allows a user, for instance with or without limited physical mobility, to pick up the bowl, place it on a work surface, such as a table or countertop, add food or water, then place it back on the floor without having to bend, kneel or reach all of the way down to the ground. The pet bowl feeding system includes a single cavity bowl or a divided bowl with more than one cavity, ranging in sizes and optionally with various heights. The bowl is formed of, for example, PVC, plastic, aluminum, silicone, or other suitable material. The material can be selected, for instance, such that the bowl is dishwasher-safe. Each bowl includes an inherent post specifically designed to work with a removable handle that incorporates a specifically designed attachment apparatus. The removable handle is optionally adjustable in length (e.g., by telescoping or collapsible mechanism) or is available in different lengths to accommodate the needs of users with different heights.

In certain embodiments, there is provided a single and/or double pet bowl feeding system with a removable handle that easily attaches to and releases from the bowl, thus allowing a user with or without limited physical mobility to pick up the bowl, place it on a table or counter, add food or water, then place it back on the floor without having to bend, kneel, or otherwise reach all of the way down to the floor. The pet bowl feeding system is simple to use, has a removable handle with adjustable lengths, and is manufacturable in various sizes and heights.

In an embodiment, the pet bowl feeding system includes a distinctive handle attachment apparatus that attaches to an integrated, inherent post, allowing the handle to easily attach to and release from the bowl. The pet bowl feeding system includes a single cavity bowl or a divided bowl with two cavities, which can range in size. Each bowl includes an inherent post specifically designed to work with the removable and adjustable handle that incorporates the attachment apparatus.

The bowl design of this feeding system incorporates an inherent post with horizontal pins specifically designed to cooperate with the handle attachment apparatus, which allows the handle to easily attach to and release from the bowl. The handle with attachment apparatus slides down onto the inherent post and locks, or attaches, by twisting the handle to the left or the right. The handle with attachment apparatus is released from the bowl by reversing the twist and lifting upward. In an example embodiment, the attachment apparatus includes an auto-leveling mechanism, such as a gyro or another tool or component. The attachment apparatus is formed of, for example, PVC, plastic, or other suitable materials. The material can be selected, for instance, such that the bowl is dishwasher-safe.

In an embodiment, different types of bowls include a universal design of the inherent post such that the removable handle with attachment apparatus is compatible with a variety of bowls including the universal design of the inherent post. In another embodiment, the handle is provided with a variety of lengths and diameters. In still another embodiment, the handle is telescopic or collapsible. The handle can also be provided with a variety of gripping and hanging apparatus options to accommodate different preferences in the grip, as well as for hanging of the handle from a hook or other mechanisms when the handle is not in use. The handle is formed of, for example, PVC, plastic, aluminum, steel, or other suitable materials. The material can be selected, for instance, such that the bowl is dishwasher-safe. The handle and the handle attachment apparatus can also be used with other devices not specifically described herein. In an example, the handle includes a foam or rubber hand-grip and, optionally, includes an opening to accommodate a hanging hook or other means of storing the handle when it is not in use.

In another embodiment, the pet bowl feeding system includes an optional integrated stand or riser that is configured to fit underneath one or more bowls, thus elevating the one or more bowls from the floor. In an embodiment, the stand remains on the floor or ground as the pet bowl is removed from the stand or replaced on the stand using the removable handle. In an example, the stand is provided with different heights in order to accommodate pets of various sizes. In still another embodiment, the stand is collapsible. The stand can also be adjustable in height or stackable. The stand is formed of, for example, PVC, plastic, acrylic, aluminum, or other suitable materials. The material can be selected, for instance, such that the bowl is dishwasher-safe.

In an exemplary embodiment, the handle is attached to the bowl by sliding the handle, with the attachment apparatus, onto the inherent post and slightly twisting/rotating the handle to lock the attachment apparatus to the inherent post. With the handle attached to the bowl, a user can lift the pet bowl feeding system from the floor or ground in an upward vertical motion, and place the bowl on a table or countertop to be filled with food or water. After filling, the user holds the handle to lower the filled bowl to the floor, then the handle with the attachment apparatus is released from the bowl by reversing the twisting motion. The handle with attachment apparatus can then be hung on a hook or otherwise stored until needed again. The same process is utilized to pick up the bowl from the floor for cleaning, moving, or storage.

In another embodiment, the bowl is generally square in shape with rounded corners and a sloped, concave, convex, or curved interior cavity, with an inherent post to enable handle attachment. The bowl can also have multiple interior cavities, with a divided bowl design. The inner portion of the bowl can also be raised with respect to the bottom of the bowl that touches the floor or ground. The design of the bowl, especially if used with the optional stand, can assist animals that otherwise are prone to eating too quickly, thus effectively reducing the occurrence of gas and bloating for those animals. In an embodiment, the bowl is provided with a non-slip bottom surface. Additionally, the bowl is formed of a food-grade plastic, stainless steel, or other suitable material to be pet- and dishwasher-safe.

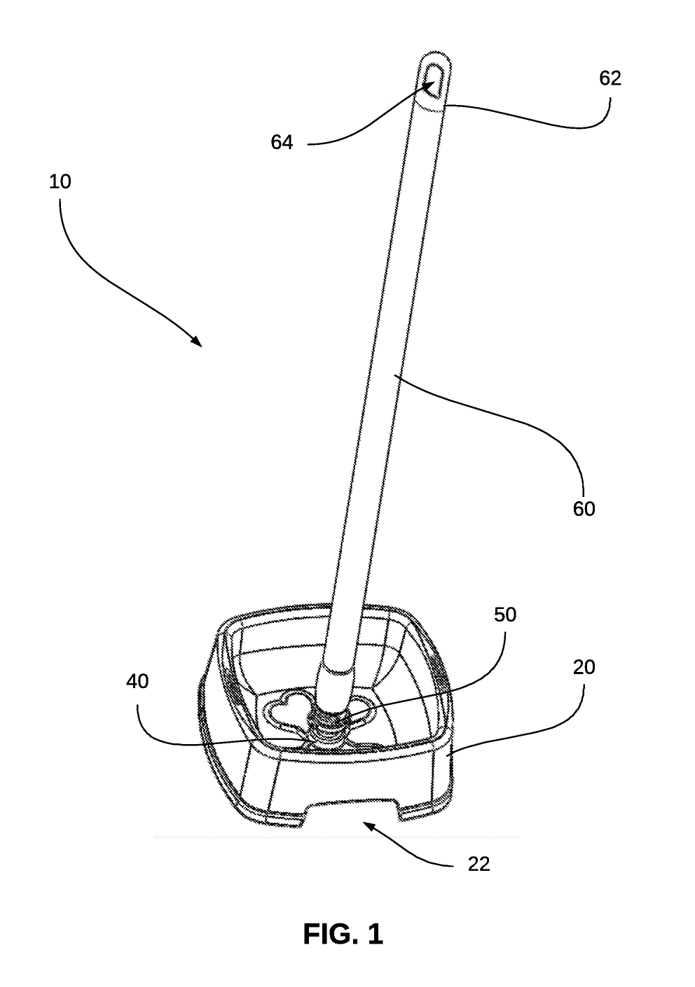

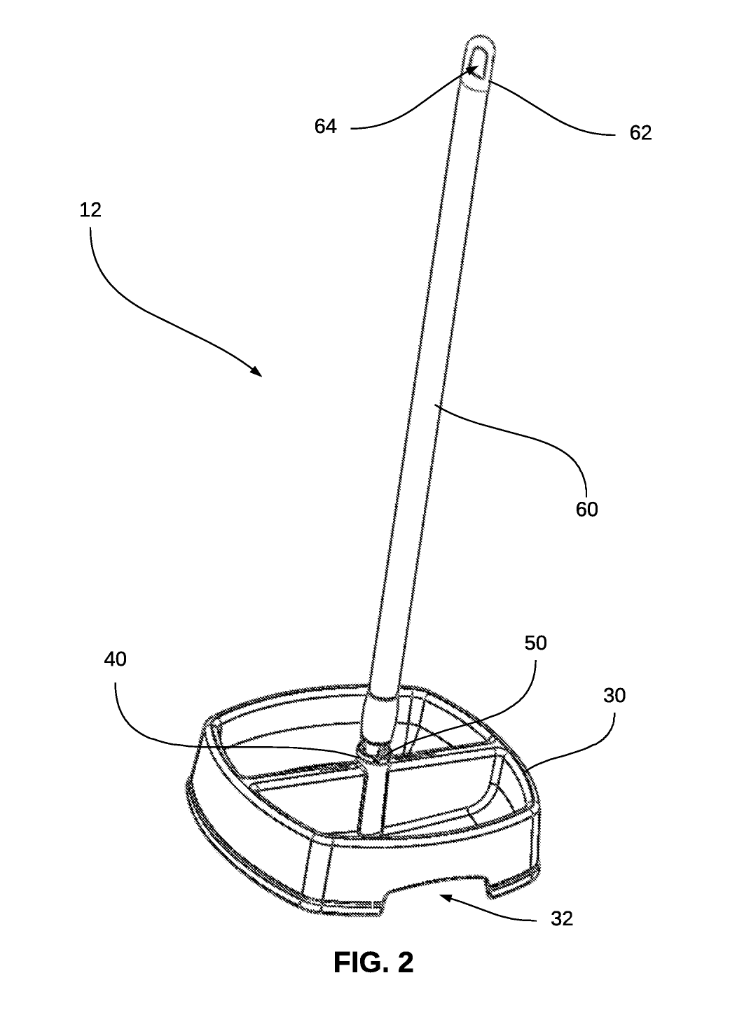

First referring to FIGS. 1 and 2, FIG. 1 illustrates an exemplary embodiment of a pet bowl system 10 with a single cavity bowl 20. FIG. 2 shows an exemplary embodiment of a pet bowl system 12 with a divided cavity bowl 30.

Pet bowl systems 10 and 12 include bowls 20 and 30, respectively, with side handle openings 22 and 32, respectively, on opposing sides of the bowl. While bowls 20 and 30 are shown as having a rounded square shape, other shapes, such as circular, oval, and square, are considered to fall within the scope of the present disclosure. Additionally, each of bowls 20 and 30 can be optionally decorated with decorative designs, logos, or other markings, without affecting the functionality of the

Continuing to refer to FIGS. 1 and 2, each of pet bowls 20 and 30 includes an inherent post 40 with horizontal pins 800 (not visible in FIGS. 1 and 2, and will be described in more detail at an appropriate juncture hereinafter), which allow an attachment apparatus 50 to latch onto inherent post 40 using a quarter- to half-turn twisting/rotating motion, and releases by reversing the quarter- to half-turn twisting/rotating motion. Attachment apparatus 50 is permanently or removably attached to a handle 60. Attachment apparatus 50 can also be integrally formed from handle 60, in an example.

Handle 60 can be provided in various lengths, or adjustable in length using a telescopic or collapsible mechanism, so as to meet the needs of users of a variety of heights. Handle 60 can also include a grip 62 formed of, for instance, foam, rubber, padding, or other suitable material for gripping. Handle 60 optionally includes a hanging mechanism 62, which includes an opening 64 which accommodates, for example, a hook or other mounting mechanisms for storing handle 60 thereon when handle 60 is not in use.

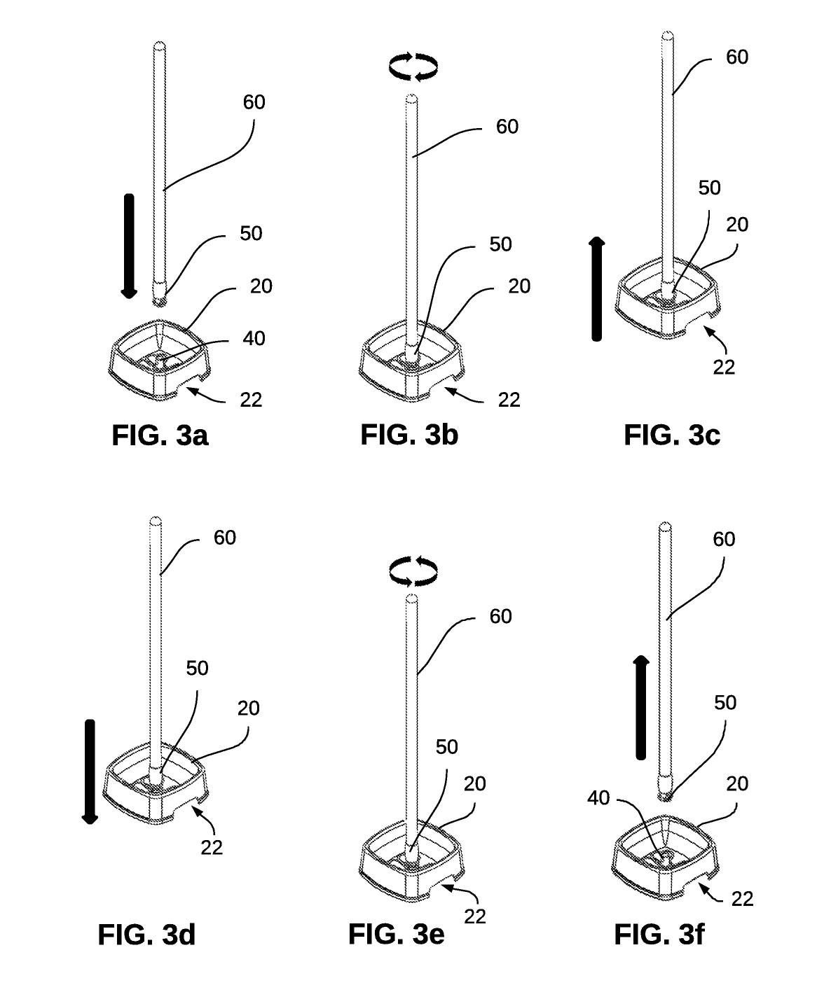

FIGS. 3a-3f illustrate an exemplary embodiment of a method for utilizing pet bowl feeding system 10. In FIG. 3a, handle 60, including attachment apparatus 50, is slid downward onto inherent post 40. In FIG. 3b, handle 60 is twisted/rotated onto inherent post 40 so as to engage attachment apparatus 50 onto inherent post 40, thus attaching handle 60 onto bowl 20. In FIG. 3c, bowl 20 is lifted from the floor by lifting on handle 60 in an upward motion and placed on a work surface, such as a table or countertop, to be filled with feed, such as pet food or water. In FIG. 3d, handle 60 is used to lower bowl 20 onto the floor. In FIG. 3e, attachment apparatus 50 is disengaged from inherent post 40 by a reverse twisting/rotating motion, thus releasing handle 60 from bowl 20. Then handle 60 is removed from bowl 20, as shown in FIG. 3f. If handle 60 includes hanging mechanism 62, handle 60 can be hung on a wall hook or other mounting means for storage until future use. The same process can be used with bowl 30, as inherent post 40 allows interchangeable use of the same handle with different bowls, or vice versa (i.e., the use of different handles with one bowl). Optionally, bowl 20, bowl 30, inherent post 40, attachment apparatus 50, or handle 60 includes a mechanism for auto-leveling, such as a gyro or another tool or component.

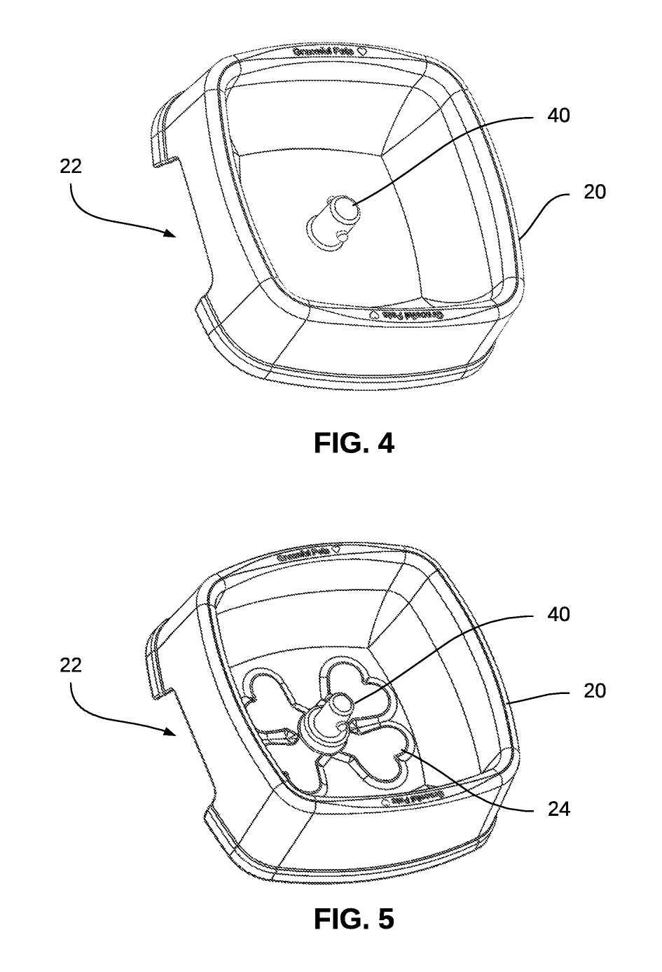

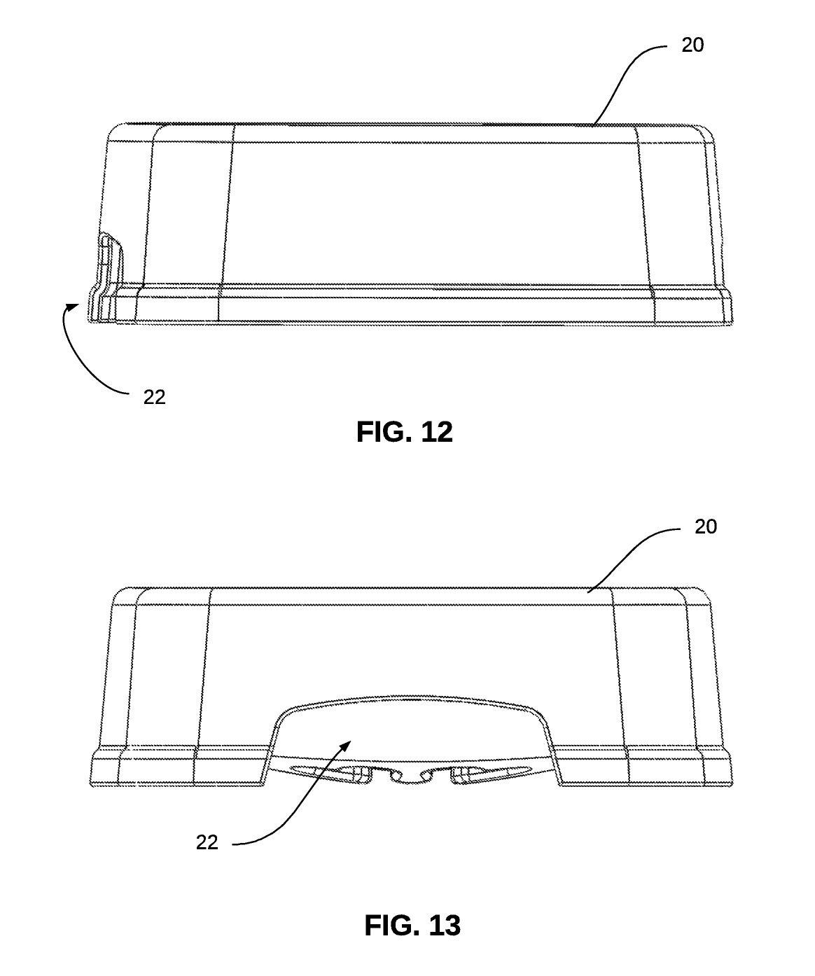

FIGS. 4-13 show details of bowl 20, side handle opening 22, inherent post 40, and attachment apparatus 50, in accordance with an embodiment, from different views. FIG. 4 shows an exemplary embodiment showing a top perspective view of bowl 20, side handle opening 22, and inherent post 40. Inherent post 40 is integrally formed from the bowl itself, or separately manufactured then later attached to bowl 20. Integral formation of inherent post 40 from the same material as the bowl allows the user to more easily clean the bowl, without embedded food debris in any nooks and crannies of the bowl, particularly on the surfaces of the bowl that comes into contact with pet food or water. Alternatively, inherent post 40 is separately formed and subsequently attached to the bowl so as to protrude from the center of bowl 20 or bowl 30. The location of inherent post 40 allows the user to more readily lift the bowl, when full, in a balanced way without spilling the contents thereof.

FIG. 5 illustrates a top perspective view of bowl 20, side handle opening 22, and an optional raised cross-bone design 24, in accordance with an embodiment. Bowl 20 (and bowl 30, in the divided bowl embodiment) can be formed with a variety of decorative designs embossed or extruded thereon, without affecting the functionality of the pet bowl system.

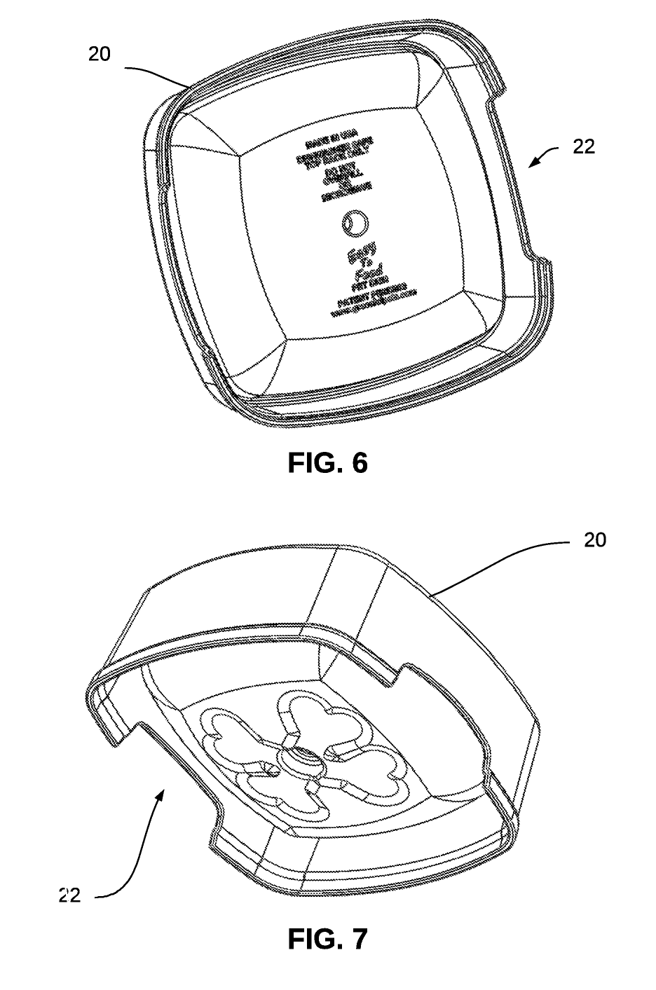

FIGS. 6 and 7 show two views of bowl 20 and side handle opening 22 from a bottom perspective, in accordance with an embodiment. As shown in FIGS. 6 and 7, additional decorative and informative features, such as user notices, decorative designs, and disclaimers can be embossed or extruded onto the bottom of the bowl without affecting the functionality of the pet bowl system.

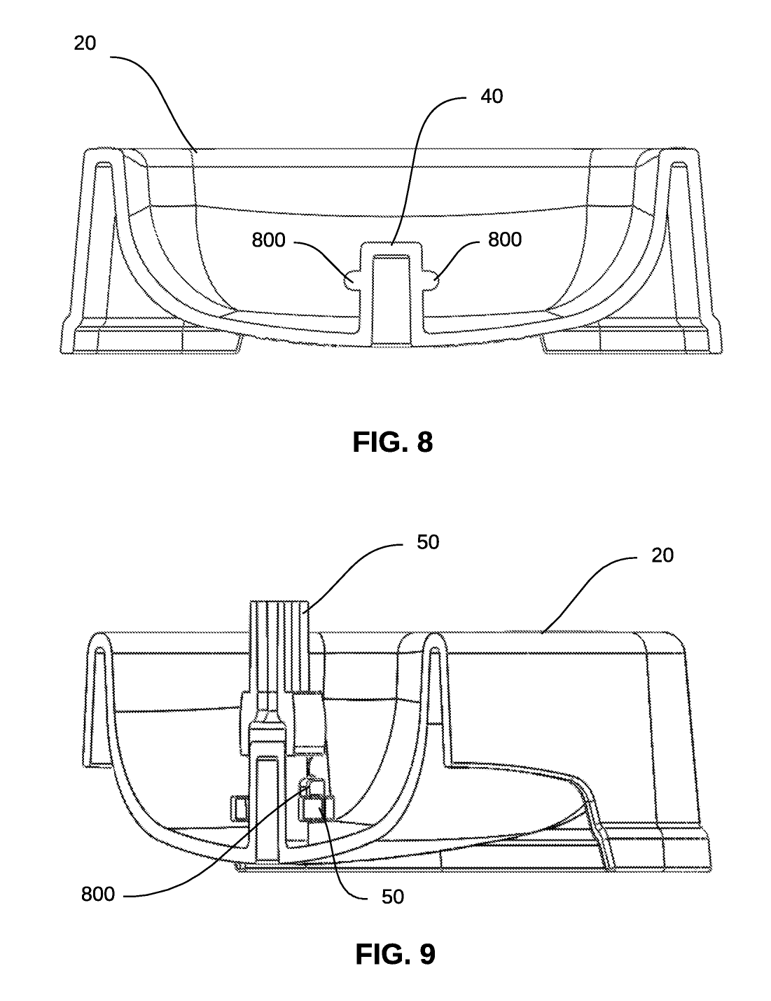

FIG. 8 is an illustration of a cross-sectional view of bowl 20 and inherent post 40, showing details of convex and concave portions of an inner wall surface as viewed from the side, in accordance with an embodiment. As can be seen in FIG. 8, inherent post 40 includes a plurality of protrusions 800 for engaging an attachment apparatus 50.

FIG. 9 is an alternative cross-sectional side view of bowl 20, inherent post 40, and attachment apparatus 50, in accordance with an embodiment. As shown in FIG. 9, attachment apparatus 50 is designed to engage protrusions 800 so as to removably attach to inherent post 40.

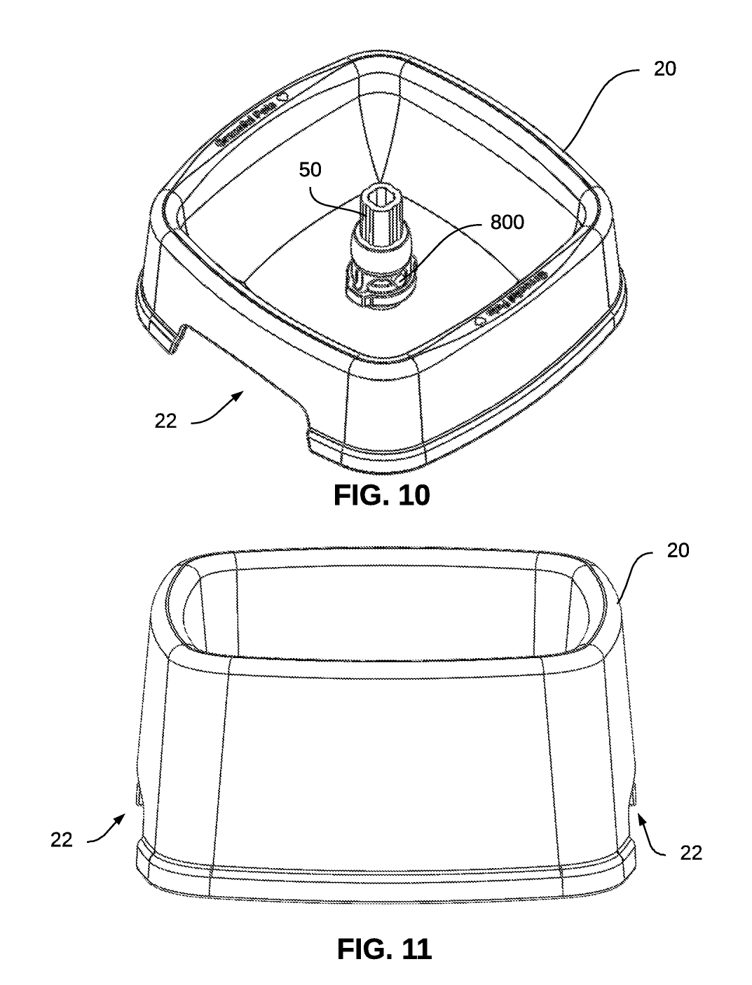

FIG. 10 shows a top perspective view of bowl 20, shown here to illustrate details of an exemplary embodiment of inherent post 40 with side handle opening 22, along with attachment apparatus 50 engaged thereon.

FIGS. 11-13 illustrate various perspective and side views of bowl 20, showing details of side handle openings 22 on both sides of bowl 20 in accordance with an embodiment.

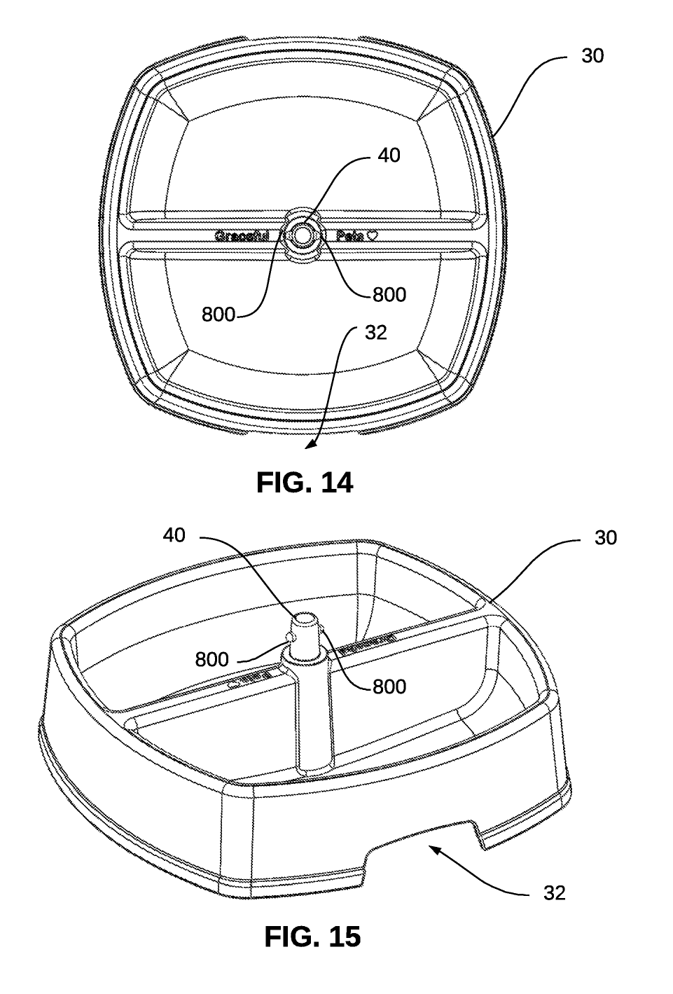

FIG. 14 shows a top view of bowl 30, a side handle opening 32, and inherent post 40, in accordance with an embodiment. Both cavities of bowl 30 are configured for accommodating a variety of soft and hard foods as well as water. The divider portion of bowl 30 can be optionally decorated with decorative designs, logos, or other markings.

FIGS. 15-18 show various views of an exemplary embodiment of bowl 30, side handle openings 32, and inherent post 40. FIG. 15 shows a top perspective view of bowl 30, side handle opening 32, and inherent post 40, including protrusions 800, in accordance with an embodiment.

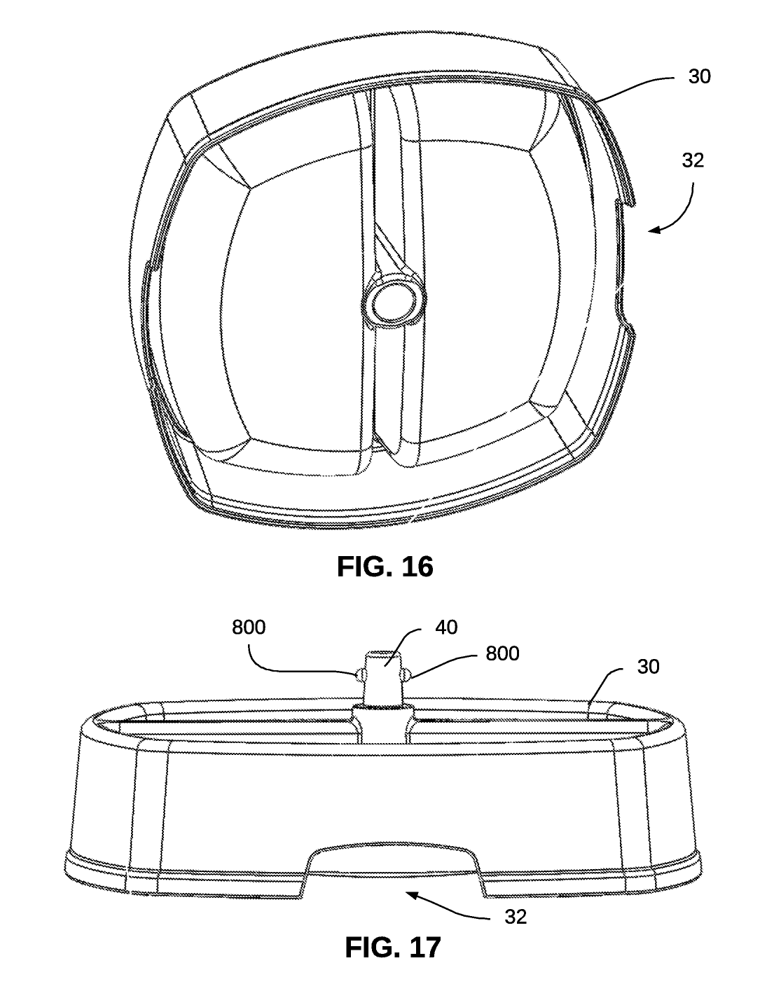

FIG. 16 illustrates a bottom perspective view of an exemplary embodiment of bowl 30 and side handle openings 32.

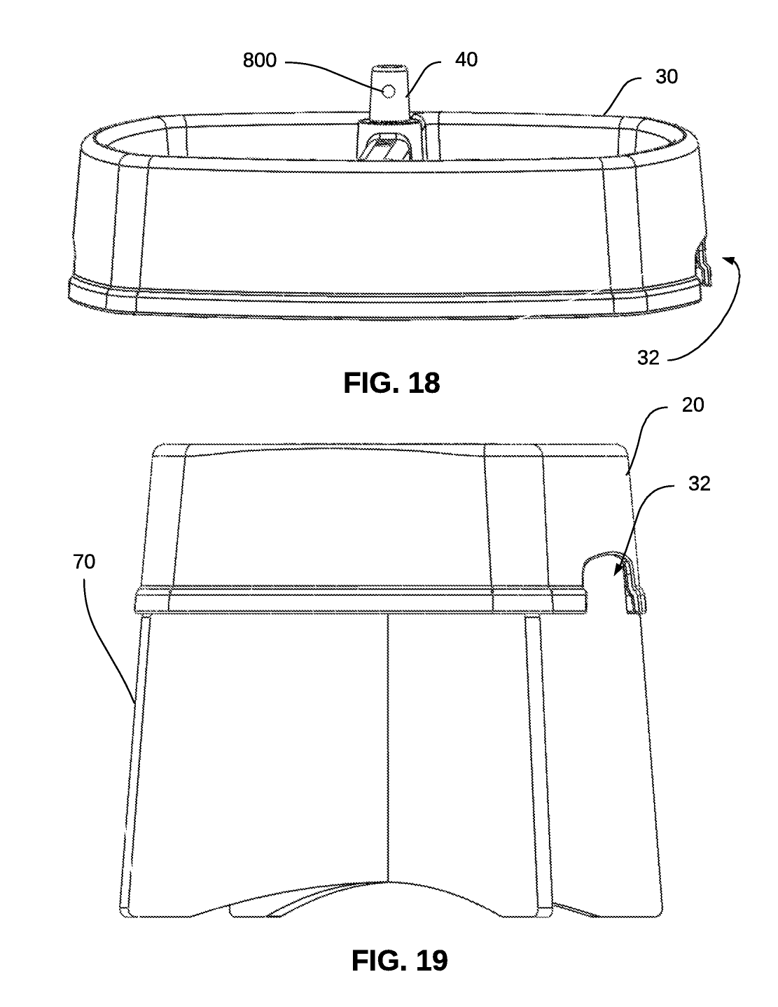

FIGS. 17 and 18 show different views of bowl 30, shown here to illustrate the position of side handle openings 32, in accordance with an embodiment.

FIGS. 19-21 show embodiments of an optional stand 70. Stand 70 can be permanently or removably attached to bowl 20 to raise the height of bowl 20 from the floor or ground. FIG. 19 illustrates bowl 20 supported by stand 70.

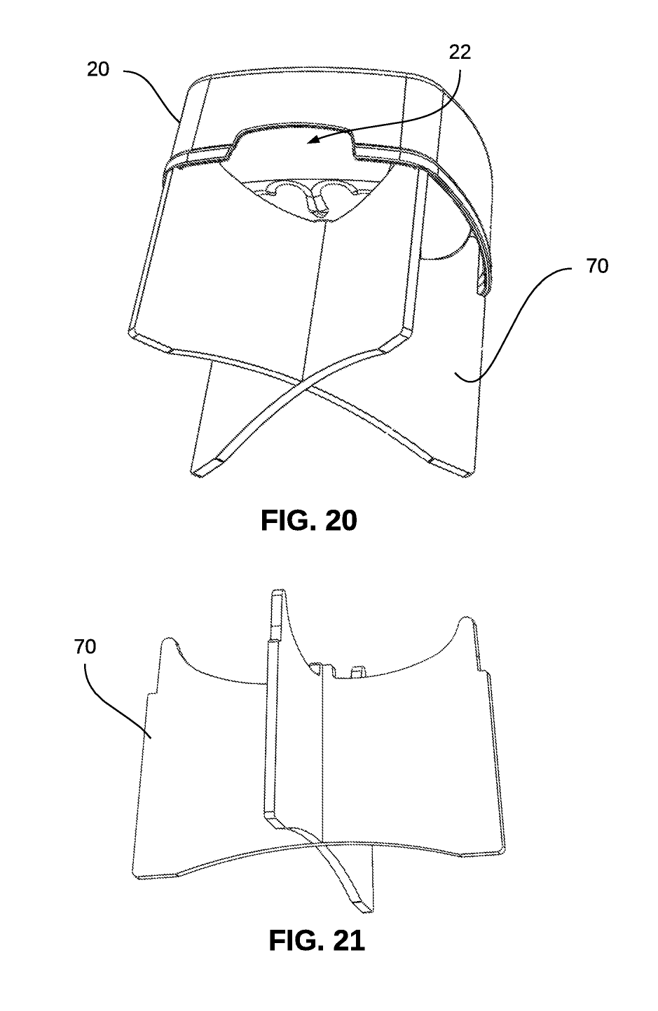

FIG. 20 shows a bottom perspective view of bowl 20 and stand 70.

FIG. 21 shows a removable embodiment of stand 70. Stand 70 is designed to fit both single bowl 20 and divided bowl 30 interchangeably.

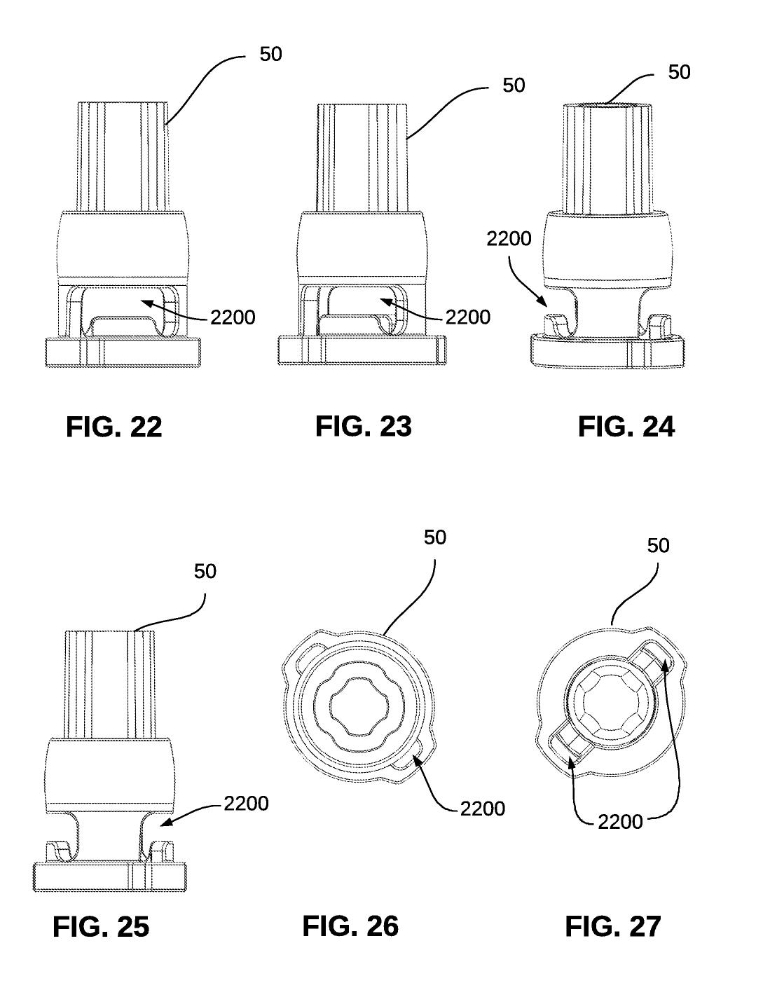

FIGS. 22-27 illustrate details of attachment apparatus 50. As can be seen in FIGS. 22-25, attachment apparatus 50 includes openings 2200 for removably accommodating protrusions 800 of inherent post 40 therein.

FIGS. 26-27 show top and bottom views of attachment apparatus 50, in accordance with an embodiment. In particular bottom view shown in FIG. 27 illustrates details of opening 2200, which is configured to fit over protrusions 800 such that, when twisted/rotated by a quarter- to a half-turn, protrusions 800 are removably engaged with opening 2200 of attachment apparatus 50, thus attaching handle 60 (not shown in FIGS. 26-27) to bowl 20 or 30 (also not shown in FIGS. 26-27).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. For example, as discussed above, a leveling mechanism such as a gyro, a bubble level, or other mechanism can be included to ensure level placement of the bowl. While the figures above show bowl 20 as being front-to-back and right-to-left symmetrical, non-symmetrical features can be added to the design without affecting the function of the system.

Accordingly, many different embodiments stem from the above description and the drawings. It will be understood that it would be unduly repetitious and obfuscating to literally describe and illustrate every combination and subcombination of these embodiments. As such, the present specification, including the drawings, shall be construed to constitute a complete written description of all combinations and subcombinations of the embodiments described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A pet bowl system for providing feed to a pet, the system comprising:
a bowl for containing the feed;
an inherent post integrally formed from the bowl, the inherent post including a plurality of protrusions thereon; and
a handle for attaching to the bowl via the inherent post, the handle including an attachment apparatus configured for removably engaging with the plurality of protrusions on the inherent post, thereby attaching the handle to the bowl.

2. The pet bowl system of claim 1, wherein the inherent post protrudes upward from a center of the bowl.

3. The pet bowl system of claim 1, in which the attachment apparatus is configured for removably engaging with the plurality of protrusions on the inherent post by twisting the attachment apparatus onto the inherent post.

4. The pet bowl system of claim 3, in which the attachment apparatus fully engages the plurality of protrusions on the inherent post by twisting the attachment apparatus onto the inherent post by less than a full turn of the attachment apparatus.

5. The pet bowl system of claim 4, in which the attachment apparatus fully engages the plurality of protrusions on the inherent post by twisting the attachment apparatus on the inherent post by less than a half turn of the attachment apparatus.

6. The pet bowl system of claim 1, wherein the handle further includes a grip arrangement.

7. The pet bowl system of claim 6, wherein the grip arrangement comprises a foam grip.

8. The pet bowl system of claim 6, wherein the grip arrangement comprises a rubber grip.

9. The pet bowl system of claim 6, wherein the grip arrangement comprises a T-bar grip.

10. The pet bowl system of claim 1, wherein the handle is collapsible.

11. The pet bowl system of claim 1, wherein the handle includes a telescoping mechanism for adjusting an overall length of the handle.

12. The pet bowl system of claim 1, further comprising a stand for elevating the bowl off of a floor.

13. The pet bowl system of claim 12, wherein the stand is removably attached to the bowl.

14. The pet bowl system of claim 12, wherein the stand is integrally formed from the bowl.

15. The pet bowl system of claim 1, wherein the handle further includes an opening for accommodating a hook therein for hanging the handle by the opening on the hook.

16. A pet bowl system for providing feed to a pet, the system comprising:
a bowl for containing the feed;
an inherent post upwardly protruding and attached to the bowl, the inherent post including a plurality of protrusions thereon; and
a handle for attaching to the bowl via the inherent post, the handle including an attachment apparatus configured for removably engaging with the plurality of protrusions on the inherent post by less than a full turn of the attachment apparatus onto the inherent post.

17. The pet bowl system of claim 16, in which at least one of the bowl, the inherent post, and the handle is formed of a material selected from PVC, plastic, aluminum, steel, silicone, rubber, and stainless steel.

18. The pet bowl system of claim 16, further comprising a stand for elevating the bowl off of a floor.

19. The pet bowl system of claim 16, wherein the stand is removably attached to the bowl.

20. A method for providing feed to a pet, the method comprising:
providing a bowl for containing the feed, the bowl including an inherent post integrally formed therefrom and in turn including a plurality of protrusions thereon;
providing a handle for attaching to the bowl via the inherent post, the handle including an attachment apparatus configured for removably engaging with the plurality of protrusions on the inherent post;
engaging the handle onto the inherent post by pushing the attachment apparatus onto the inherent post, then twisting the handle by less than a full turn in a first direction, thus removably coupling the attachment apparatus onto the inherent post;
lifting the handle upward so as to raise the bowl onto a work surface;
filling the bowl with feed;
using the handle, lowering the bowl from the work surface down to a lower location; and
disengaging the handle from the bowl by twisting the handle in a second direction opposite from the first direction.
